(19) United States
(12) Patent Application Publication
(10) Pub. No.: US 2005/0076247 A1
(43) Pub. Date: Apr. 7, 2005

(54) Device for the password-protected handling of an electronic document

(76) Inventor: Erland Wittkotter, Buende (DE)

Correspondence Address: ALSTON & BIRD LLP;BANK OF AMERICA PLAZA, 101 SOUTH TRYON STREET, SUITE 4000, CHARLOTTE, NC, 28280-4000, US

(21) Appl. No.: 10/175,127

(22) Filed: Jun. 19, 2002

Related U.S. Application Data
(63) Continuation of application No. PCT/EP00/13270, filed on Dec. 27, 2000.

(51) Int. Cl. H04L 9/00

(52) U.S. Cl. 713/202; 713/182

(57) ABSTRACT

A device for password-protected accessing of a functional unit with a password input unit, which is designed for the entry of a password by a user, a password verification unit, which is connected downstream of the password input unit, and which is designed, preferably by means of an assigned password memory unit, for checking that the password entered is correct, and which is designed to activate the functional unit into a predetermined, first function operation on establishing a correctly entered password, the first function operation corresponding to an appropriate operation intended by the user, and the password verification unit having assigned to it a password generation unit, which is designed to create a first password as the correct password, the password generation unit being designed to create at least one second password, which on input by the user in the password input unit is recognized by the password verification unit as the second password, and the password verification unit, in response to recognition of the second password, is designed to initiate a second predetermined function operation of the functional unit, the second function operation being an operation that differs from an explicit error message or an error routine, which operation is different from the first function operation and does not correspond to the operation intended by the user.

The present invention relates to a device according to the preamble of claim 1 or claim 6 and to a corresponding method. This technology is known in the form of an encoding system and usually consists of an encoding unit for producing an encoded document, which is consequently protected against unauthorized access; and a decoding unit or password-verification unit, which on input of or electronic combination with the correct key restores the original open document.

Numerous procedures for achieving such an electronic encoding exist in the prior art in the form of encoding algorithms, encoding methods etc.

However, all these procedures from the prior art have the common feature that typically one key is suitable for the correct decoding, and consequently for rendering the encoded content usable, while any input of a keyword not corresponding to the correct key (said keyword insofar as equivalent can also hereinafter be regarded as a key data set) leads to an unusable result, and this is also directly recognizable for the user in question. In other words, known decoding devices or encoding methods are clearly and directly recognizable as regards the success or failure of a decoding.

However, in the case of many applications this fact can be a disadvantage or can encourage a person seeking unauthorized access—should he through the input of a chosen key obtain as the decoding result an output that is obviously wrong for him—to make further decoding attempts until he actually obtains the desired, correct decoding result. It is at that very stage—when as a result of the lack of additional security measures, or through the appropriate skills of the person seeking unauthorized access (who hereinafter will also be described as a hacker), the possibility will exist that a large number of decoding attempts with appropriately varied input of keys can be made—that known encoding methods therefore lead to a security deficiency. This applies in particular to automated, so-called password-cracking programs, which produce and check a wide range of possible keys with the aid of electronic lists (e.g. dictionaries, address books or telephone directories).

The object of the present invention is to overcome this security deficiency and to improve the security of existing encoding devices and encoding methods. In particular, it is to be ensured by means of the present invention that a hacker is prevented from making as many attempts at access as he wishes until in the end the true, open content of the document to be protected is at his disposal.

The object is achieved by the device with the features of claim 1, claim 6 and the corresponding methods; advantageous further developments of the invention are described in the subclaims. Independent protection within the scope of the invention is also claimed for an application relating to an access or log-in procedure of the type that could be appropriate when, for example, booting up or calling up user (text or similar) data files.

In an advantageous manner according to the invention, the invention achieves an uncertainty effect as far as an unauthorized user is concerned, namely to the effect that an improper input of a password leads to a reaction of the functional unit and, typically, the unauthorized user recognizes this reaction as an intended reaction (function). Accordingly, he will subsequently stop making further unauthorized attempts at access.

In a typical embodiment of the invention, which corresponds to the currently known best mode, the present invention relates to a password-protected accessing of an electronic document encoded in the manner described, in this case the general password idea being applied to the plurality of keys (first key or the at least one second key).

In an advantageous way according to the invention, it does not in fact become obvious to the hacker whether his input of a key has actually led to the correct result, or whether the decoding result that he has achieved corresponds merely formally to the original, protected data set (is equivalent to it), but in fact the content is not usable for him. Concrete examples will be discussed further on in the description of the figures; merely by way of example, it should be stated for a better explanation that such a decoding result achieved by input of the second key can be, for example, a sentence structure or a product of figures which formally, i.e. in their structure, their grammar etc. can make sense to the hacker, but the actual content of which differs in such a way from the original data set that the decoding result is in fact not usable for the hacker. However, since he usually cannot recognize this at the time of his decoding operation, he will stop his further attempts at access on receiving the formally correct decoding result, with the result that the increased security intended according to the invention is achieved.

In particular in a situation where within the scope of the present invention a large number of second keys is generated (as against, for example, only a first, correct key or a quantity of first keys), it is therefore highly likely that the hacker will in the course of his unauthorized access attempts reach a decoding result that is not the same as the original data set, so that the protection effect of the present invention is correspondingly reinforced. Owing to the vagueness and confusion achieved with the present invention, in other words the fact that it cannot be recognized whether the decoding result achieved actually corresponds to the correct, original data set, an entirely new dimension in data protection is consequently established.

The operations set out in the main claim are advantageous for achieving the invention, which operations are also further described as semantic encoding, and which within the known formal structure provide the prerequisite for changing the content while retaining formal equivalence (in this respect the term “grammar” should also be understood as a set of conventions and rules whose use makes the original data set and also the decoding result achieved with the second key look as if this is a regular result, for example a grammatically correct, (apparently) meaningful sentence. In particular, by means of the operation of replacing information components provided within the scope of the present invention, for example by a grammatically corresponding (=equivalent) component, which is, however, different in content, this effect can be achieved in a particularly advantageous way, for example by the fact that value specifications in figures are replaced by other value specifications, or that personal names are changed for others, or that place names are changed for others, and so on (without, of course, the present invention being restricted to this simple operation).

The present invention is particularly advantageously further developed by the fact that an authorized or unauthorized user does not directly enter the keys (or rather link them by way of electronic operations), but enters a password, typically consisting of only a few elements, and consequently, for example, also easily retainable, as the access or entry control and verification instrument, together with a suitable unit, which password is then linked, by way of the key data file provided according to the further development, with appropriately the first or second key, and this key is then used in the decoding unit for the decoding. By means of such a key data file, which consequently determines an assignment between the passwords to be entered by the user and the keys actually to be used, it is additionally possible to make available a large number of passwords, to assign said passwords to one or more of the second keys and in particular also to admit passwords which are specially predetermined, and which lead to the correct result (i.e. first key) or to the result that is merely formally correct, but incorrect as regards content (i.e. the second key); this seems particularly suitable for those applications in the case of which the passwords that a hacker would typically use for an unauthorized access attempt can already be imagined, and the second key—and consequently also the merely formally correct decoding result—could automatically be assigned already beforehand to such passwords that are used as expected (with the effect that the hacker would probably then interpret this result as already the correct decoding attempt and consequently stop further decoding attempts).

Alternatively or in addition, the password and also the key data file (or an assigned key processing unit) are formed in such a way that the input of a password initiates an indirect assignment operation, for instance a jump in the key data file, which is in the form of a table, so that the possibilities for flexible password and key assignment can be extended further.

In principle, it is also possible within the scope of a possible embodiment of the invention to use the terms “key” and “password” synonymously.

In general, it should be remembered as regards the present invention that the information components of an electronic document according to the invention possess a meaning that makes sense to the user, and are in the form of written words, numerical values, single pictures, film and/or sound sequences or frames, or combinations of these, in the case of which grammar forms a sorting system of the formal structure underlying the written words, numerical values, single pictures, film or sound sequences or frames.

Another preferred further development of the invention additionally provides means for the aspect of storage according to the invention of a password-protected access or the password-protected access to an electronic document, which means are provided for the assignment of a plurality of passwords in an n:1 ratio for the second key and/or means for the user to predetermine at least one password by entering it in the key data file unit.

In other possible further developments of the invention the manipulation unit according to the concrete embodiment of the encoding unit provided according to the further development has assigned to it a random control unit which controls the exchanging, removal, adding and/or replacing by the manipulation unit as regards individual information components and/or sequence(s) of information components in a random and in particular non-reproducible way.

In addition or alternatively, provision is made according to a further development according to the invention for the manipulation unit to have assigned to it an encoding parameter unit, which is designed for the storage and/or setting of predetermined parameters for the exchanging, removal, adding and/or replacing by the manipulation unit, in particular relating to an encoding depth achieved by a number of exchanging, removal, adding and/or replacement operations.

It is further advantageous, according to a further development, in addition to connect a conversion unit downstream of the manipulation unit, which conversion unit is in the form of a reconstruction data file that is designed to create an electronically transmissible volume data file from the encoded data set as the encoded form of the electronic document, in addition to a preferred actively executable program and/or script data file from the key data set.

Whilst the present invention has its primary application fields in the protection of electronic data and data files, both at local and also at remote level, the range of applications is unlimited. For instance, it should be suitable also in particular to use the present invention in the extremely sensitive area of access protection on PCs.

Further advantages, features and details of the invention emerge from the following description of an exemplary embodiment with reference to the figures, in which:

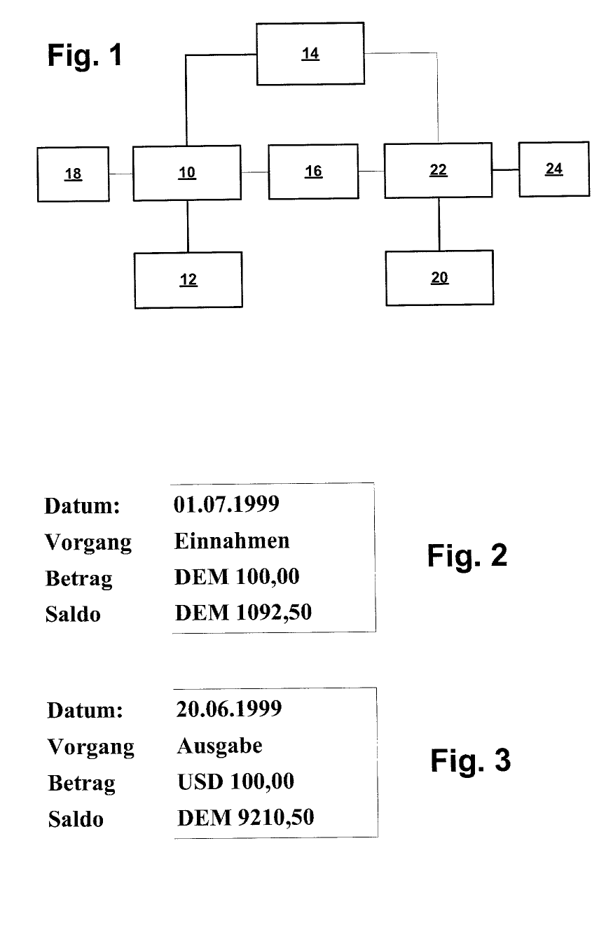

FIG. 1: shows a schematic block diagram of the device according to the invention, according to a first embodiment;

FIG. 2: shows an illustration of a data record decoded with the first key, which corresponds to an original data record;

FIG. 3: shows an illustration of a data record decoded with the second key, which is not usable as regards content, but is formally equivalent to the original data record;

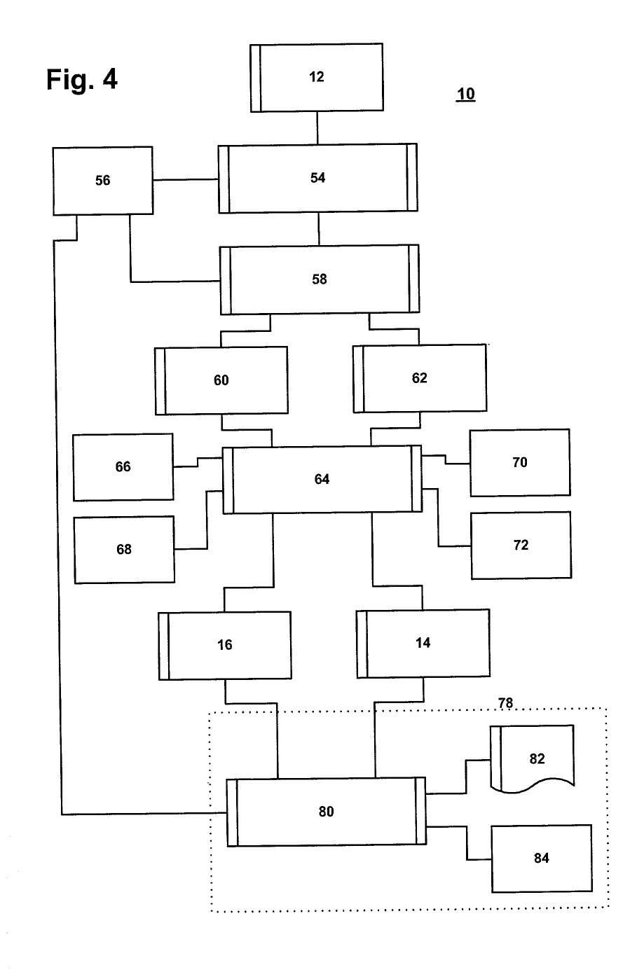

FIG. 4: shows a schematic block diagram of the function components of the encoding unit 10 in FIG. 1: and

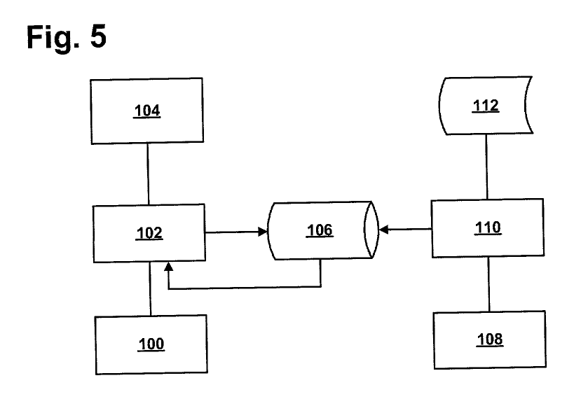

FIG. 5: shows a schematic block diagram of a further embodiment of the present invention, which in that respect embodies the general idea of the invention.

An encoding unit 10, usually in the form of a commercially available PC, is designed in the manner shown in FIG. 1, with an input unit 12 for original data, in the present case internal reporting data of an organization, with financial data. By means of the unit 12 (additionally or alternatively in the form of a data memory unit), data to be appropriately encoded are fed to the encoding unit 10, which then creates an encoded data set (encoded data file) and stores the latter in a data memory unit 14. The key data file required for the correct decoding is filed at the same time in a key data file unit 16, and a password, by means of which a user can access the correct key data file (also further called first key), is communicated to the user by means of a password interface or output unit (18) in a suitable manner, e.g. through display, printout, entry or input by the user, or the like.

When an authorized user from now on enters the correct password again in the system by way of a password input unit 20, a decoding unit 22 connected downstream accesses the key data file unit 16 with this password, receives from there the correct decoding data file (the first key), subsequently performs the decoding operation on the encoded document (i.e. the corresponding data set) stored in the data memory unit 14 and transmits the correct decoded result by way of a suitable output unit 24, e.g. a screen, printer or the like, to the user.

Thus far the system described, or its functionality corresponds to devices from the prior art; in addition, however, the function components shown in FIG. 1 are characterized by the following technical features:

On the one hand, the encoding unit 10 performs an encoding operation on the original data file to be encoded (the original data record), which encoding operation consists of exchanging and/or removal of an information component in the original data set, addition of an information component at a predetermined position in the original data set, or replacement of an information component with an information component not usually contained in the original data set. This operation, which is further also to be referred to as semantic encoding, is disclosed in the international patent application PCT/EP 00/06824 as a method for encoding an electronically stored, original data set and, as regards the creation of the key or the decoding described there, should be considered as belonging to the invention and included in full in the present description of the application.

By way of example, the semantic encoding carried out is explained with reference to the first example of FIGS. 2 and 3; for instance, FIG. 2 shows an original data file, or the result of a correct decoding of a semantically encoded original data file, and FIG. 3 shows a corresponding data set, such as can be the result of a semantic encoding. As in fact can be seen from the comparison of FIGS. 2 and 3, in the case of the data records in question, which describe a transaction process in the internal, company-specific information system of the exemplary embodiment, it is a matter in each case of an accounting operation which even after encoding has taken place (FIG. 3) is still recognizable as an accounting operation, although the various data contents are modified. For instance, the date is still recognizable as a date, but in terms of content is a date differing from the original date of FIG. 2. The same applies to the specification of the operation, the original content component “input” having been replaced here by a grammatically equivalent content component “output”, just as with regard to the amount the stated currency “DEM” has been replaced by an equivalent currency “USD”. Finally, by way of example, it is shown in the example of the balance that by transposing the amount a sum of money is, of course, again obtained, but in terms of content it does not correspond to the original sum.

The device according to FIG. 1, and there in particular the encoding unit 10, possesses the feature that it creates at least one encoded data record according to FIG. 3, which data record in fact, as explained above, in terms of its form corresponds to a correctly decoded or original result, but in terms of content differs from the latter and is consequently unusable for the user (or a person gaining unauthorized access); without further checking measures, the person gaining access is not, however, in a position to establish whether in the case of the data record of FIG. 3 this is in fact a correct decoding as far as content is concerned.

In other words, within the scope of the present invention, suitable execution of the encoding operation in the semantic manner described above with the specified operations produces at least an encoding result that in terms of content is still encoded, but as regards form and structure does not allow an unauthorized person who has gained access to establish whether in fact the correct result as regard content has been obtained, without making a check on the content.

This technical measure is used within the scope of the present invention in order to increase the security of the encoding system shown in FIG. 1: namely by the fact that by carrying out the encoding operation the encoding unit 10 creates the first key (which permits the restoration of the original data record according to FIG. 2) and, in addition, creates at least one second key, which leads to a decoding result according to FIG. 3, which decoding result shown in FIG. 3 can make a person who has gained unauthorized access abandon further attempts at decoding or access, on the assumption that he has already in fact obtained the result that he wanted.

While in principle the keys (first and second key) created in this way can already be regarded as passwords within the scope of the present invention, it would seem particularly appropriate in practice to assign to the first key (the first key data file) or the second key (the second key data file) passwords in each case by means of the encoding data unit 16 (or alternatively by means of a unit producing an algorithmically created connection), which passwords can be formulated in shorter and more compact form than the key data files, which of necessity possess a certain data volume.

Specifically, a key data file A (for FIG. 2) or B (for FIG. 3) would in fact contain all those particulars and operations necessary for restoration or production of the data sets that are equivalent in form in each case, for instance the replaced terms, index details for a sequence shift etc., so that a direct handling of the keys (or key data files), e.g. in the form of character strings, is not very practicable. If, on the other hand, as shown in accordance with Table 1 below, relevant passwords in the form of a four-digit number are assigned to the key data files A in question (for the correct decoding according to FIG. 2) or B (for the decoding according to FIG. 3, which is correct purely in form, but is not accurate as regards content), the handling is clearly easier for the user, since he now only needs to note the relevant password:

TABLE 1
Assignment of password and key data file in key data file unit 16

| Password | Key data file |
|---|---|
| 7123 | A |
| 2106 | B |
| 1302 | B |
| 1111 | B |
| 2312 | B |

As can be seen from Table 1, in the present exemplary embodiment the encoding unit 10 generates a correct key data file A, to which the password “7123”, to be entered in the input unit 20, is assigned. In parallel, however, in the exemplary embodiment shown the encoding unit 10 produces four further passwords (or said passwords are suitably entered by the user), to which in each case the key data file B is assigned, with the effect that on input of, for instance, the numeral sequence “1302” the decoding unit 22 produces the result according to FIG. 3.

It is particularly preferable in this case to choose the number of passwords leading to an output according to FIG. 3, which is correct only in form, but is not usable as regards content, in such a way that said number is clearly greater than the number of passwords for the correct key data file A; the likelihood of an unauthorized person who accesses said file reaching the decoding result according to FIG. 3 by trying out or additional input can be influenced accordingly. Any input outside the passwords shown in Table 1 would in the present case lead to an obviously unusable decoding result. A variant of this output of the decoding result could consist of the recognizability of the incorrect or unusable decoding result lying in a special form, design or characterization of the decoding result which is known to the user as such; possible examples here might be, for instance, a special color of an output document, an arrangement of a picture or of a graphic element, a certain position, an acoustic signal or the like.

It is also particularly preferable to create the possibility according to a password input unit or password selection unit (not shown in the figure) of taking into account in the table for the key data file unit particularly relevant password entries that can usually be expected from an offender or unauthorized person, in such a way that the decoding result that is correct purely in form is already assigned to these probable accesses beforehand. Typical applications for this are, for instance, in the case of passwords consisting of numerals, dates of birth or similar number combinations, where an unauthorized person usually assumes that they have been selected or used as passwords, and it can consequently be expected that an unauthorized person is likely to start off his first access attempts with these. Hacker attacks can therefore be countered more efficiently by a preselection possibility for the passwords.

A further development possibility or preferred variant of this exemplary embodiment consists of not explicitly entering predetermined (preselected) passwords, but where necessary of suitably bringing up these from an electronically available (typically extensive) selection list, for instance of a dictionary, and regarding them as selected passwords. This would then have the consequence that, for instance, in the case of a plurality of improper access attempts, likewise based on an electronic list (dictionary), it is possible to respond in the short term with the reaction provided according to the invention, namely initiation of the second function operation, after which it is to be expected that the person gaining improper access will stop his hacking attempts.

A further possibility for further development of this inventive idea, but also of the preceding general idea of the invention, is to activate or deactivate a plurality of selected passwords (second passwords within the scope of the invention) in a parameterized, preferably randomized way, so that this supplementary measure also creates the possibility that passwords provided as second passwords within the scope of the invention nevertheless do not lead to a function initiation or to an error message or the like.

A preferred further development of the invention makes provision—with a view to a correct password, for example “7123” in Table 1, leading to the result—for the system to produce automatically a fuzziness according to the invention, through the fact that neighboring characters of this character array, e.g. “8123”, “7234”, “7122” and so on, are automatically assigned “B” as the key data file. The security of the traditional password-protected data access is also further increased in an effective manner by this measure.

A practical constructional embodiment of the encoding unit 10 and of the infrastructure for semantic encoding of the relevant aspect of the present invention is described below with reference to FIG. 4.

FIG. 4 in this case shows in a schematic block diagram illustration the layout of the encoding unit 10 as the key production and management unit with the function components belonging to it within the scope of the present invention, which can be used to convert electronic documents protected by the semantic encoding technology according to the invention into the protected data set (volume data file) and associated keys (key data files or key data sets). The embodiment within the scope of the invention described in connection with FIG. 4 makes it possible here not only to produce just one key data set (leading to the original, correct data set when restoration occurs), but a plurality of possible keys, so that also through this aspect of the presence of a plurality of key data sets (one of which again leads to the correct result also in terms of content, and not only to the seemingly correct result) the security of the present invention can be achieved.

As an alternative example to that of FIGS. 2 and 3, an electronic text document will be described with reference to FIG. 4, which document is present in a usual format (e.g. Microsoft WORD) and was drafted with suitable text editors. The text document consists of the sentence

Peter goes at 20.00 hours to the station. The train is on time.

It is stored in the memory unit 12 according to FIG. 4 and is to be semantically encoded in the manner described below by the effect of the further function components shown in FIG. 4.

A reader/access unit 54, which is connected downstream of the document memory unit 12 and interacts with a format data unit 56, establishes that the above document stored in the memory unit 12 follows the MS-WORD format structure (ideally the format data unit 56 contains all format or structure information of common data formats), and with this (data file-related) format information accesses the text document in the document memory unit 12. The analysis unit 58 connected downstream of the reader/access unit 54 is from now on in a position, on the basis of the document information read by the reader unit 54, to analyze and evaluate said information, the analysis unit 58, on the one hand, breaking up the electronic document into its individual information components and saving these components in an information component memory unit 60 (in the present example these would be the individual words), and in addition recognizing the document structure as the structure of two sentences limited by full stops, and saving this document structure in broken-up form in the document structure memory unit 62. To this extent, the content of the unit 62 receives the character of a document-specific metafile, which subsequent encoding operations can access (also only selectively, if desired).

Specifically, the content of the document structure memory unit could be as follows after the analysis of the initial document by the analysis unit:
Sentence 1 (1, 2, 3, 4) Sentence 2 (1, 2, 3),
   while the information component memory unit 60 contains information components corresponding to this structural analysis, i.e. words:
   (1.1) Peter
   (1.2) goes
   (1.3) at 20.00 hours
   (1.4) to the station
   (2.1) the train
   (2.2) is
   (2.3) on time

With this preparation, which is important for the subsequent performance of the encoding operations, it is possible from now on to carry out the basic operations of the semantic encoding both on the individual information components (in the present example the individual words) and on the sequences of information components or structures, namely the exchange, removal, addition or replacement. In this respect, an important protective effect of the semantic encoding according to the invention lies in the fact that these operations are not carried out at will, but rather that they are carried out while retaining the grammatical, syntactical and/or format rules, so that also as a result of the encoding a result that appears to be correct (i.e. without checking of content) is obtained, in other words, in the case of which it cannot be seen that it is in fact an encoded result.

In the present exemplary embodiment the following text is obtained from the abovementioned electronic document by means of the encoding unit:
Thomas comes at 16.00 hours from the churchyard. The train is on time.

If the true content is not known, this sentence therefore seems to be an open, uncoded result, so that an essential, protection-justifying effect of the present invention already lies in the fact that a hacker as regards this text possibly does not even gain the impression at all that this is an encoded text, and therefore stops accessing this text right from the start.

Specifically, in the present exemplary embodiment, through the effect of an equivalence unit 70 (which in its simplest version can be understood as a table or database of equivalent, i.e. corresponding and exchangeable terms), the following was performed: The content component “Peter” of the initial document was replaced by the grammatically equivalent content component “Thomas”, with sentence structure and grammar being retained, but with the meaning of the original document already being destroyed. In a corresponding way, the content component “goes” in the original document was replaced by the equivalent component “comes”, the content component “at 20.00 hours” was replaced by “at 16.00 hours” (here through the effect of the equivalence unit it was found that it was a matter of a numerical date in the form of a time of day, so that a manipulation within the permissible times of day was possible), and the content component “to the station” was replaced by the content component “from the churchyard”. At the same time it was ensured by means of a semantic control unit 72, likewise connected to the manipulation unit 64 and influencing the encoding operation described above, that the encoding result “ . . . comes . . . from the churchyard” is grammatically and syntactically correct, in that respect therefore not identifiable as having been manipulated. (The additional “to” would also be correct here). It was also established by means of the manipulation unit 64 and the interacting equivalence unit 70 or semantic control unit 72 that the content component “the train” of the next sentence has a content relationship with the newly entered content component “churchyard”, so that even without an encoding of the second sentence a totally different sentence (and consequently an encoding effect) is produced.

In particular, the functionality of the equivalence unit 70 or of the semantic control unit 72 corresponds to an electronically accessible form of a thesaurus or the like, by means of which it is already possible, for instance in the case of words, to find and further evaluate equivalent or opposite (although conceptually matching) terms.

In addition, provision is made in the exemplary embodiment of FIG. 4 to allow an encoding depth of the encoding achieved by the encoding unit 10 according to FIG. 4 to be preselected. For instance, an encoding parameter unit 66 is in fact assigned to the manipulation unit 64, which encoding parameter unit makes the course of the individual operations achieved by the manipulation operation in the unit 64 capable of being controlled or influenced and thus makes it possible for an encoding depth or a number of individual operations to be influenced. This can be achieved in particular also randomly, and in fact by means of the random control unit 68, which is likewise assigned to the manipulation unit.

As a result of these simple encoding operations described above, the encoding result
Thomas comes at 16.00 hours from the churchyard. The train is on time.
   is consequently output as volume data (i.e. as an encoded data set) and saved in a memory unit 14 provided for it, while a first key for the reconstruction (in the present exemplary embodiment information on the relevant exchanged words with their position in the sentence and in the relevant conceptual terms) is saved in the key data file memory unit 16. Appropriately, the relevant first key data file for the memory unit 74 could be as follows (in the example that follows the command EXCHANGE is interpreted by the reconstruction unit, in order to perform the specified exchange in the argument):
   EXCHANGE (1.1; Thomas)
   EXCHANGE (1.2; comes)
      and so on.

In a further development of this embodiment, the vocabulary of the command language is even dynamic and can be changed by functions of a script language: the command EXCHANGE could in this way even be replaced by another arbitrary term

According to the invention, provision is further made for a plurality of key data files to be produced and . . . [lacuna] in the memory unit 16, only one of which, however, produces the correction reconstruction result. Key data file 2 could appropriately begin as follows:
EXCHANGE (1.1; Rüdiger)
(Remainder as above key data file);
   Key data file begins with:
EXCHANGE (1.1; Claus)

In the exemplary embodiment of FIG. 4 an output unit 78 is additionally connected downstream of these two memory units, which output unit prepares the plurality of keys 16 in a particularly simple manner in the form of scripts and can output them as executable script data files 84; this is achieved by means of a conversion unit 80, which in an otherwise known manner produces from the volume data of the memory unit 14 a volume document 82 corresponding to the encoded version, and from the index or reconstruction data of the memory unit 60 several structure descriptions that are executable independently in the context of a suitable process environment produces scripts, e.g. such as JavaScript, XML, VB-Script or the like, and which in the case of the script data file belonging to the first key then independently during the processing can process the volume document 82 and return it to the original, uncoded form.

In the embodiment shown diagrammatically in FIG. 4 it is suitable to create not only one key data file for the memory unit 16 (i.e. as an executable script file 84), but to create a plurality of these files, but only one of which again leads to a result that actually has the correct content, while other key data files as scripts initiate an encoding operation, which likewise leads to a meaningful (and consequently seemingly correct) result, but the content of which does not correspond to the original version. In this way an increase in the encoding security is then achieved. It should be directly clear here that even slight deviations in content completely destroy the sense (which actually forms the value for a user) of the original document, so that it may possibly require only slight modifications or a small number of encoding operations (resulting in a correspondingly short script data file as key data) to achieve the intended protection purpose, to the extent of the already mentioned non-encoding of the original data file, which derives its protection purpose purely from the fact that a person gaining unauthorized access is unsure whether he is dealing with an open content (i.e. also corresponding to the original data file), or with an encoded content (i.e. not corresponding to the original data file).

As already mentioned, the present invention is not limited to the example given of numerical data files or text data files. For instance, it is also particularly appropriate to encode any other electronic documents by the method described in principle, so long as these electronic documents have a structure that is suitable for the basic operations of exchanging, removal, addition or replacement from content components. Typical applications are in particular music data files, which are usually present in MP3 format, and in the case of which it is possible within the scope of the present invention to replace, remove or exchange the data structures (so-called frames) predetermined by the MP3 format individually or in blocks (ideally also by bar or section, according to the piece of music in question). The same applies to picture and/or video data files, for in that case too the common, known document formats are based on a sequence of frames as content components (in the case of pictures or electronic videos these are the individual pictures in each case), which can be manipulated in the manner according to the invention.

Other possible and advantageous further developments of the invention provide for a reconstruction data file, in particular in the form of a script or the like to be present in an ASCII and/or HTML data file format. In particular, in regard to a firewall protecting a client unit and/or sender unit, simplified possibilities are consequently presented for penetrating such a firewall without being intercepted.

Another advantageous further development of the invention provides for a reconstruction data file to be embedded suitably in electronic document data (of the same or of a different data file type), in such a way that in this way format and (reproduced) content of such a guest data file remain unchanged; in a particularly advantageous manner, an area of the guest data file which does not directly affect content, so e.g. comment or information areas etc., is therefore suitable for such a hidden transmission of reconstruction data files, for the purpose of a further increase in security.

In particular, the possibility of achieving the key or reconstruction data files according to the invention as scripts offers numerous options for a further development: for instance, the script-controlled combination within the scope of the present invention as a further development permits greater flexibility or a further increase in security by the fact that not only a script data file as a reconstruction data file permits restoration of the uncoded form of the electronic document through combination, but a plurality of scripts as reconstruction data files is necessary, which e.g. cover predetermined time sections of the electronic document and then call each other up in sequence. As an example, the invention could be achieved here in such a way that a script data file in each case as a reconstruction data file for a time section of approximately 30 seconds of an MP3 piece of music permits reconstruction, and then a further reconstruction makes the (again script-controlled) call-up of a subsequent, further script data file for reconstruction necessary. In addition to an increased security effect, possibilities for a context-dependent generation or reconstruction of the original document, even including the possibility of restoring different variants of the original document in a context-dependent and purposeful way, are obtained in this way.

A further embodiment of the present invention is described below with reference to FIG. 5, which embodiment corresponds to the most general form of the present invention and defines the functional unit according to the invention as an initially abstract functional unit that can be achieved with any desired functionalities, either as a device for document encoding and document decoding according to the exemplary embodiment described above with reference to FIG. 1, or additionally or alternatively as a device for controlling or initiating a payment operation, for carrying out a(n) (electronic) communications process, for identifying and/or authenticating a user, or (in general) for carrying out a suitably preset program operation on a data processing device. In this respect, the invention also includes the fact that the functional unit according to the invention (in particular according to Patent claim 6) in the first and second function operation is operable by means of at least one control parameter, means being provided additionally for deriving the control parameter from the first and/or second password. In a concrete practical embodiment, this control parameter (which is usually also present in a plurality) would influence an encoding or decoding operation of the functional unit. In concrete terms, this would then correspond to the first exemplary embodiment described above with reference to Table 1 or FIG. 1, where in fact by means of a unit keys are assigned to the first or second passwords, and these keys in that respect correspond to the control parameters provided according to the further development. In that respect, the control parameter provided according to the further development also goes beyond a (traditionally, of course, already known) activation or deactivation of functional unit, depending on whether a correct password has been entered: control parameters within the meaning of this aspect of the invention should namely be understood in particular as those that directly determine the operational sequence functionality of the functional unit, which parameters influence the first and also the second function operation in the manner according to the invention. For instance, it is in particular also within the scope of the invention to include control parameters provided according to a further development not solely as parameters derived from keys or to be assigned to a key, but in particular also as internal variables or other directly function-relevant parameters which are ideally critical elements in the sequential execution of the function operation of the functional unit without direct exploitation or possibility of access by a user.

Particularly important is the aspect of the control parameters in conjunction with or achieved by keys in a combination provided according to a further development, which combination in the manner described above semantically encodes electronic documents or documents of similar content, i.e. as control parameters in the semantic encoding process.

As shown in FIG. 5, for interaction with a user an input unit 100 for a password is provided, which input unit can typically be composed of a keyboard or the like. Said input unit 100 has connected downstream of it a password verification unit 102, which in the exemplary embodiment described by means of a password data file device 106 checks that the password entered is valid or corresponds to stored passwords and in response to this comparison sends a corresponding control signal to a functional unit 104 connected downstream.

Provision is made according to the present invention for a first password stored in the memory unit 106 to be recognized as the correct password and subsequently to initiate a first function operation (in the same way as in the first embodiment according to FIG. 1, this would then mean the assignment of the key data file A according to Table 1 from the first exemplary embodiment).

On the other hand, if the password verification unit 102 establishes by interrogation of the data memory unit 106 that a password entered in the unit 100 by a user corresponds to one of the second passwords (likewise saved in the data memory unit 106, preferably in a plurality), a predetermined second function operation according to the invention, which does not, however, correspond to that actually intended by the user, is initiated. In the concrete embodiment of FIG. 1 described above (Table 1) this would be the case where key B is assigned to the plurality of keys according to the table, which would be an example for the plurality of second keys according to the invention.

FIG. 5 also describes a device that makes it possible to create the first and also the second password, preferably present in a plurality, in the manner according to the invention. This is achieved in the manner shown by a password generation unit 110, which is assigned to the data memory unit, and which communicates with the user by means of a password communication unit 108, the unit 108 either being designed for a user input of the second key, preferably provided in a plurality, (and/or of the first key) or the first and/or the second key is/are automatically generated by the unit 110 and then output to the user by means of the communication unit 108.

A particularly advantageous variant in the exemplary embodiment of FIG. 5 shows the list unit or dictionary unit 112, which is assigned to the password generation unit 110 and according to a further development ensures that a (smaller) number of passwords is not created in a decided manner and subsequently stored in the unit 106, but that a password can be fed to the unit 106 (for the purpose of verification of the password by unit 102) dynamically and automatically from the plurality of terms or password entries saved in the unit 112. In this respect, a particularly suitable example for the unit 12 would be an electronic dictionary or an electronic thesaurus.

In practical operation the user enters a password in the system by means of the unit 100. The password verification unit then establishes one of three possible operational cases: Either it is a correct password (first password), which then proceeds to initiate the first, predetermined (and intended) function operation of the functional unit 104; or alternatively, in the case of the password entered it is a second password within the meaning of the invention, i.e. the verification unit 102 recognizes this password as one that is present in the memory unit 106 (or one that is brought up by the dictionary unit 112), but also recognizes that this password does not correspond to the first password. Consequently, the decision of the password access unit causes the initiation of the second function operation of the functional unit 104, which again is a planned, predetermined function operation, which does not, however, correspond to the required (intended) one. In practice, this could, for example, be achieved by the fact that in the case of a document reproducing unit as the functional unit 104 an incorrect or not selected document is reproduced, or in the case of a program execution unit as the functional unit 104 that an unintended or planned program runs.

The third possibility as a reaction to the user input in the unit 110 is that the password verification unit 102 establishes that neither the first nor one of the second passwords has been entered. Consequently, a normal rejection or error routine is output, as expected or typically produced also in the case of conventional, password-protected systems as a reaction to an incorrect password entry.

The present invention is not limited to the exemplary embodiments described. On the contrary, it should be clear in particular from the description of FIG. 5 and the indicated context that the invention can be applied to a multiplicity of uses and password environments; in that respect the exemplary embodiments and functionalities described, in particular of unit 104, should be understood as being purely by way of example, and the exemplary embodiment described with reference to FIG. 1 represents only a concrete (although particularly advantageous) embodiment of the present invention. It also goes without saying that advantageous further developments of the concrete embodiment according to FIG. 1 can also in the same way be further developments of the more general embodiment of FIG. 5.

1. Device for password-protected accessing of an electronic document by means of a password as the key, having:
an encoding unit, which is designed to carry out an encoding operation on an electronically stored original data set, in order to create an encoded data set and to create and output a first key, and
a decoding unit, which is designed to decode the electronically stored, encoded data set and also to restore the original data set in response to a manual input or electronic linking of the first key,
characterized in that
the encoding unit is designed to create additionally at least one second key, said second key being formed in such a way that a decoding of the encoded data set with the second key leads to a formally correct and seemingly usable decoding result which differs from the original data set, but which decoding result has the incorrect con ent is not usable for a user,
the encoding unit being designed to carry out the following operation is on the original data set, which consists of a sequence
of information components of a metalanguage in the form of a script language or of information components from data elements disposed in a predetermined, standardized formal structure characterized by a grammar
and stored in memory areas:
exchanging or removing an information component in the data set, or adding an information component at a predetermined position in the sequence of information components, or replacing an information component with an information component not contained in the original data set,
the first key containing details of the exchanged, removed, added or replaced information components, and being formed in such a way that it permits a restoration of the original data set by the decoding unit,
and the second key containing such details of the exchanged, removed, added or replaced information components that the decoding result is a sequence of information components in the predetermined formal structure that differs from the original data set or has information components that have been replaced in comparison with the original data set.

2. Device according to claim 1, characterized by a key data file unit assigned to the encoding unit and also the decoding unit, which key data file unit is designed to store the first and the second key and also to store a plurality of passwords, the passwords being capable of being entered in the device by the user, and the first or the second key being assignable to the passwords by the key data file unit for purposes of the restoration.

3. Device according to claim 1, characterized in that the encoding unit has:
an analysis unit, which is designed to access an information component and to record electronically at least a sequence of information components of the original data set in response to predetermined and/or ascertained format and/or structure data of the original data set,
a manipulation unit, which is connected downstream of the analysis unit, and which is designed to exchange and/or remove an information component in the original data set and/or add an information component at a predetermined position in the sequence of information components and/or replace an information component with a preferred information component not contained in the original data set, and also to create a key data set as a reconstruction data file with details of the exchanged, removed, added and/or replaced information components, which is formed in such a way that it permits a restoration of the original data set.

4. Device according to claim 3, characterized in that the manipulation unit has assigned to it an equivalence unit, which for at least one information component in the original data set keeps to hand at least one equivalence information component electronically stored, the equivalence information component being formed in such a way that it corresponds grammatically, in format and/or syntactically to the information component concerned.

5. Device according to claim 3, characterized in that the manipulation unit is designed to interact with a semantic control unit, which is designed in such a way that the exchanging, removal, addition or replacement is carried out within the grammar, format and/or syntax that is determined by the format and/or structure data.

6. Device for password-protected accessing of a functional unit, having
a password input unit, which is designed for the input of a password by a user,
a password verification unit, which is connected downstream of the password input unit, and which is designed, preferably by means of an assigned password memory unit, for checking that the password entered is correct, and
which is designed to activate the functional unit into a predetermined, first function operation on establishing a correctly entered password,
the first function operation corresponding to an appropriate operation in ended by the user,
and the password verification unit having assigned to it a password gene ration unit, which is designed to create a first password as the correct password,
characterized in that
the password generation unit is designed to create at least one second password, which on input by the user in the password input unit is recognized by the password verification unit as the second password and the password verification unit, in response to recognition of the second password, is designed to initiate a second predetermined function operation of the functional unit,
the second function operation being an operation that differs from an explicit error message or an error routine, which operation is different from the first function operation and does not correspond to the operation intended by the user.

7. Device according to claim 6, characterized by a password communication unit, which is designed for the user to enter or preselect the first and/or the at least one second password for the password generation unit.

8. Device according to claim 6, characterized in that the password generation unit has assigned to it an electronic list unit or dictionary unit, which performs the creation of the first password and/or of the at least one second password on the basis of at least one entry of the electronic list unit or dictionary unit.

9. Device according claim 6, characterized in that the functional unit is a device for displaying an electronic document, a device controlling or initiating a payment operation, a device identifying and/or authenticating the user, an electronic communications unit carrying out a communications operation and/or an electronic data processing device carrying out a programmed operation.

10. Use of the device according to claim 1 for releasing access to locally stored and offered electronic documents, or those stored and offered by way of a long-distance data transmission system, including document lists, in an electronic data processing unit, in particular a PC.
